(19) United States
(12) Patent Application Publication
(10) Pub. No.: US 2026/0205636 A1
(43) Pub. Date: Jul. 16, 2026

(54) Method and device for coding and decoding image sequences

(71) Applicant: ORANGE, ISSY LES MOULINEAUX (FR)

(72) Inventors: Felix HENRY, Chatillon (FR); Theo LADUNE, Chatillon (FR); Pierrick PHILIPPE, Chatillon (FR); Gordon CLARE, Chatillon (FR)

(21) Appl. No.: 19/136,657

(22) PCT Filed: Dec. 5, 2023
(86) PCT No.: PCT/EP2023/084249

§ 371 Date: Jun. 6, 2025

(30) Foreign Application Priority Data
Dec. 9, 2022 (FR) FR2213098

(51) Int. Cl. H04N 19/91; H04N 19/136

(52) U.S. Cl. CPC H04N 19/91; H04N 19/136

(57) ABSTRACT

A method and device for coding and decoding a sequence of at least two images having a plurality of samples. The decoding method includes: decoding a first group of feature maps; decoding a set of parameters representative of a neural network; for a sequence of samples, referred to as current samples, of the respective images of the sequence to be decoded, associated with a position in the respective images: constructing a feature vector from the feature maps of the first group, on the basis of the position of the current samples; processing the vector by way of an artificial neural network defined by the decoded parameters so as to deliver a sequence of vectors respectively representative of the current samples.

### PRIOR ART

The invention relates to the general field of encoding sequences of digital images. More specifically, the invention relates to compressing digital videos.

Digital videos are generally source encoded to compress them in order to limit the resources required for their transmission and/or storage. There are many encoding standards, such as the standards of the ITU/MPEG organizations (H.264/AVC, H.265/HEVC, H.266/VVC, etc.) and their extensions (MVC, SVC, 3D-HEVC, etc.).

An image is generally encoded by dividing the image into a plurality of rectangular blocks, and by encoding these blocks of pixels in a given processing sequence. In existing video compression techniques, processing a block typically comprises predicting the pixels of the block carried out using previously encoded and then decoded pixels present in the image being encoded, in which case “Intra prediction” is referred to, or using previously encoded images, in which case “Inter prediction” is referred to. This use of any spatial and/or temporal redundancies avoids transmitting or storing the value of the pixels of each block of pixels, by representing at least some of the blocks using a residual representing a difference between the prediction values of the pixels of the block and the actual values of the pixels of the predicted block.

Video formats are continuously evolving for even greater compression and to adapt to the variety of expected formats and communication networks, the prediction possibilities are becoming ever greater and the conventional encoding and decoding algorithms are very complex.

In addition to these conventional approaches proposed by the compression standards (MPEG, ITU), approaches based on artificial intelligence, and notably neural intelligence, are tending to develop.

Some of these neural approaches can be considered to be a simple extension of the notion of competition of the aforementioned compression techniques, such as the prediction mode competition and video encoding transformation.

Other approaches use the “autoencoder” concept. Autoencoders are artificial neural network-based learning algorithms that allow a new representation of a dataset to be constructed. The architecture of an autoencoder is made up of two parts: the encoder and the decoder. The encoder is made up of a set of layers of neurons, which process the data in order to construct new representations, called “encoded” representations, also called “latent representations”. In turn, the neural layers of the decoder receive these representations and filter them in order to attempt to reconstruct the original data. The differences between the reconstructed data and the initial data allow any errors made by the autoencoder to be measured. The training involves modifying the parameters of the autoencoder in order to reduce the reconstruction error measured on the various samples of the dataset. The performance capabilities of such autoencoder-based systems are achieved at the expense of a considerable increase in the memory footprint and in complexity compared with conventional approaches, such as those proposed by the compression standards. They can have millions of parameters and can require up to one million MAC (multiply-accumulate) operations to decode a single pixel. This makes such decoders much more complex than conventional decoders, which could hinder the adoption of learning-based compression.

More recently, a simple neural network-based image encoding technique has been described in the article entitled, “Compression with Implicit Neural representations” by Emilien Dupont et al., (arXiv: 2103.03123). The proposed encoding technique involves adjusting a neural network to an image, quantizing the weights of the network and transmitting them. When decoding, the neural network is evaluated in each pixel position in order to reconstruct the image. Such a technique nevertheless remains inefficient in terms of compression and requires independently encoding the images in the video.

A requirement therefore exists for a solution for simply and efficiently encoding/compressing a sequence of images.

### DISCLOSURE OF THE INVENTION

The aim of the invention is a method for encoding a plurality of images as claimed in claim 1 and a method for decoding a plurality of images as claimed in claim 8.

Within the meaning of the invention, the term “encoding” or “coding” is understood to mean the operation involving representing a set of samples, or pixels, in a compact form conveyed, for example, by a digital bit stream. Decoding is understood to mean the operation involving processing a digital bit stream in order to render decoded samples.

The term “sequence of images” is understood to mean a plurality of two-dimensional images ordered, for example, in a temporal manner in the case of a video. According to another example, the images can be views of the same scene represented as multiple views. According to another example, the images can be a plurality of temporal and multiple view images (immersive video).

The term “sample” is understood to mean a value sampled from an image of the sequence. Sampling a signal produces a sequence of discrete values, called samples. In the case of an image signal, the sample is referred to as a pixel, which can be, for example, a color pixel that is traditionally represented by a triplet of values, for example, (R, G, B) or (Y, U, V). The position of the sample is identified by its coordinates on the abscissa (x) and on the ordinate (y) in the image. A sequence of samples refers to a series of samples considered at the same coordinates in the series of respective images of the image sequence.

The term “feature maps” is understood to mean an abstract representation of a sequence of images, i.e., at least two images, comprising a plurality of variable data, also called values, for example, real numbers. These maps are also called “latent representation”.

The expression “transforming feature maps” is understood to mean applying a mathematical operation that allows the values of a first map to be transformed into values of a second map. A first map, called map of the first group, and which is intended for encoding, can be any kind of map. A second map, called transformed map, or map of the second group, has the same resolution as the input images, i.e., it contains as many values as an input image (respectively to be decoded) contains samples (N). The transformation can involve, for example, an interpolation, up-sampling, filtering, quantization, a Fourier transform, etc.

The expression “data feature vector constructed from feature maps as a function of a position” is understood to mean a vector made up of one or more, preferably discrete, elements or data, with the data being constructed from the feature maps in a position determined by the position of the samples being processed in the images. This feature vector is the one input into the neural network. In the case of an image, such a vector can be constructed, for example, from a plurality of values sampled in each of the feature maps at the same x-and y-coordinates as the samples to be encoded (respectively to be decoded). Once these values are sampled from the feature maps, they can be processed in order to form the feature vector, before being entered into the neural network, for example, by quantization, filtering, interpolation, etc.

The term “neural network” or “synthetic neural network” is understood to mean a neural network, such as a convolutional neural network, a multilayer perceptron, an LSTM (Long Short-Term Memory), etc. The neural network is defined, for example, by a plurality of layers of artificial neurons and by a set of activation, weighting and addition functions (for example, one layer can compute y=f(Ax+b), where y and b are vectors of dimension N, x is a vector of dimension M, A is a matrix of dimension M×N, and f is the activation function).

The expression “parameter of the neural network” is understood to mean one of the values that characterizes the neural network, for example, a weight associated with one of the neurons (filter coefficient, weighting, bias, value affecting the operation of the non-linearity), etc.

The expression “processing using a neural network” is understood to mean applying a function expressed by a neural network to the input feature vector, in order to produce an output vector representing the sample to be encoded (respectively to be decoded). This output vector can comprise one or more data representing the sample.

The term “performance measurement” is understood to mean a measurement between at least one value of a sample to be encoded and a decoded value of said sample. The measurement can evaluate, for example, a distortion, or a perceptual error. It can be performed on one sample or on a plurality of samples (for example, the current samples, or the current images, etc.). The measurement can also comprise a measurement of the bit rate, in particular the bit rate associated with encoding the neural network and/or encoding the feature maps of the first group. The measurement can be a joint measurement of the bit rate and the distortion achieved by weighting them. As is well known in the prior art, the value of this measurement is generally minimized until a target value is reached.

The term “construction step” is understood to mean a step that aims to construct the parameters representing the image, before they are actually encoded. The construction sub-steps can be reiterated as many times as necessary in order to obtain an acceptable performance measurement.

Generally, the steps of an encoding or decoding method should not be interpreted as being associated with a notion of temporal succession. In other words, the steps can be performed in an order different from that indicated in the independent encoding or decoding claim, or even at the same time.

The encoding method according to the invention constructs encoding parameters from a sequence of input images, by training a neural network on feature vectors associated with a position of a sample to be encoded in each input image. These feature vectors are constructed from feature maps that can have the resolution of the input images, or can have lower resolution. During training, or construction, the parameters of the neural network and the values of the feature maps are updated as a function of a performance measurement, for example, of the bit rate-distortion type. When the training has ended, i.e., the obtained performance measurement is satisfactory, the actual encoding of the parameters of the neural network and the values of the feature maps can be performed and stored, or transmitted to the decoder.

Advantageously, the training process allows the parameters of the neural network and/or the values of the feature map to be refined until a representation is obtained that is adequate in terms of performance, for example, until a desired balance is obtained between the generated bit rate and the distortion experienced by the input images. The training of the values of the feature maps and of the parameters of the neural network can be carried out jointly. Advantageously, the encoding method according to the invention allows the image signal to be efficiently compressed by exploiting the intra-image spatial redundancies, but also the inter-image redundancies between the images in the sequence, whether it is a sequence of video images or a plurality of multiview images, a series of medical images, etc.

Advantageously, the decoding method is simple since the feature maps and the neural network simply need to be decoded in order to reconstruct a decoded version of a sequence of images.

Such a neural network advantageously can have a very simple structure with few parameters.

According to embodiments of the encoding or decoding method:
The method comprises a step of transforming said first group of feature maps in order to obtain a second group of feature maps with the resolution of the images of the sequence, with the method being characterized in that said feature vector is constructed from said feature maps of the second group.

Advantageously, according to this embodiment, the feature maps are divided into two groups, one of which is reserved for extracting the feature vectors and the other for the encoding. It is thus possible to separate the two methods, which have a different purpose: the maps of the first group to be encoded (respectively to be decoded), must be compressed as efficiently as possible, while the maps of the second group must be able to facilitate the process of extracting and constructing the feature vector.
According to one variant, at least one of the feature maps of the first group has lower resolution than that of said images to be encoded (respectively to be decoded) and the transformation operation involves up-sampling. Advantageously, according to this embodiment, the compression of the feature maps is more efficient since at least one of the feature maps of the first group, to be encoded (respectively to be decoded) contains fewer values than if it had the resolution of the images. For example, one of the feature maps in the first group can have a resolution of ½, i.e., it contains half as many x- and y-values as the input image contains samples, i.e., in total 4 times fewer values than a feature map with the resolution of the image. In contrast, the feature map of the second group, which corresponds to a transformation of this map of the first group, has identical resolution to that of the images. The transformation therefore in this case comprises at least one up-sampling operation, so as to obtain the same number of values in this transformed map as one of the input images (respectively to be decoded) contains samples.
At least one of said feature maps of the first group has the same resolution as that of the images to be encoded (respectively to be decoded).

Advantageously, according to this embodiment, at least one of the feature maps has the same resolution as the input images to be encoded (respectively to be decoded), allowing high fidelity and compliance with the details of the initial resolution of the images of the sequence. According to one embodiment, in this case the transformation retains the number of values of the transformed feature map. It can be reduced to the identity (no processing is performed on the values of the map of the first group) or comprise a filtering operation, a quantization operation, a Fourier transform, etc. In the encoding, quantization is essential for the correct operation of the system if the feature maps comprise, for example, floating or real values. They need to be quantized before they are encoded and/or input into the neural network. In contrast, in the decoding, inverse quantization is not always necessary, depending on the embodiments.
Constructing said feature vector comprises a sub-step of extracting a value from said at least one feature map in an identical position to that of the current samples in the images to be encoded (respectively to be decoded).

Advantageously, it is possible to extract a value from a feature map of the first or second group, in the same position as the samples in the images of the sequence (input images for the encoding, images to be decoded for the decoding), in order to construct an element of the feature vector. This method is simple to implement. For example, if J input feature maps are available, with the same resolution as the images of the sequence, a simple extraction of the values of the maps at the coordinates of the current samples (on the same abscissa and the same coordinate in the feature map) allows the feature vector of J elements to be directly constructed.
The construction of said feature vector comprises the following sub-steps:
extracting a plurality of values of said feature maps of said first group as a function of said position of said current samples;
processing said extracted values in order to obtain the feature vector.

Advantageously, according to this embodiment, the feature vector is extracted from the feature maps, which can be arbitrary, and notably with lower resolution than that of the images to be encoded (respectively to be decoded), before undergoing processing. Such processing can correspond, for example, to quantization of the extracted data, or scaling, or filtering, etc. For encoding, quantization is essential for the proper operation of the system if the feature maps include floating, or real, values, for example. They need to be quantized before they are encoded and/or input into the neural network. In contrast, in the decoding, inverse quantization is not necessary, depending on the embodiments.
The method comprises a step of constructing a group of additional feature maps and the feature vector is also constructed from said additional feature maps. Advantageously, these additional maps of a third group, which are constructed identically in the encoder and the decoder, are neither stored nor transmitted in the decoder, nor decoded in the decoder. They thus allow additional data to be used to improve compression without degrading the bit rate. They can include, for example, coordinates, causal data available in the maps of the first or second group, data regarding other images already processed by the encoder or decoder, etc.

According to one variant, an additional map contains a value representing the temporal distance between the images in the video.
Encoding (respectively decoding) said first group of feature maps comprises a sub-step of entropy encoding (respectively decoding). Advantageously, entropy coding allows any redundancies in images to be used that can remain in the feature maps, with the images of the sequence thus being compressed more efficiently.

Correlatively, a further aim of the invention is a device for encoding and a device for decoding sequences of images.

The features and advantages of the encoding or decoding method equally apply to the encoding or decoding device according to the invention, and vice versa.

A further aim of the invention is a computer program on a storage medium, with this program being able to be implemented in a computer or a control device according to the invention. This program includes instructions designed to implement the corresponding method. This program can use any programming language, and be in the form of source code, object code, or intermediate code between source code and object code, such as in a partially compiled format, or in any other desirable format.

The invention also relates to a computer-readable information medium or storage medium comprising instructions for the aforementioned computer program. The information or storage media can be any entity or device capable of storing the programs. For example, the media can include a storage means, such as a ROM, for example, a CD-ROM or a microelectronic circuit ROM, or even a magnetic storage means, for example, a floppy disk or a hard disk, a DNA sequence, or a flash memory. Moreover, the information or storage media can be transmissible media such as an electrical or optical signal, which can be routed via an electrical or optical cable, by radio link, by wireless optical link or by other means.

The program according to the invention particularly can be downloaded over the Internet.

Alternatively, each information medium or storage medium can be an integrated circuit incorporating the program, with the circuit being designed to execute or to be used to execute a method according to the invention.

### BRIEF DESCRIPTION OF THE DRAWINGS

Further features and advantages of the present invention will become apparent from the following description, with reference to the appended drawings, which illustrate embodiments thereof that are by no means limiting.

FIG. 1 schematically shows an encoding device used within the scope of the invention;

FIG. 2 schematically shows a decoding device used within the scope of the invention;

FIG. 3 illustrates an example of a synthetic artificial neural network used within the scope of the invention during encoding and decoding;

FIG. 4 is a flow chart representing an example of an encoding method that can be implemented by the encoding device of FIG. 1;

FIG. 5 shows an illustration of an encoding method used in one embodiment of the invention;

FIG. 6 is a flow chart representing an example of a decoding method that can be implemented by the decoding device of FIG. 2;

FIG. 7 shows an illustration of a decoding method used in one embodiment of the invention.

### DESCRIPTION OF THE EMBODIMENTS

FIG. 1 schematically shows an encoding device ENC.

This encoding device ENC comprises a feature map generation module GEN, a transformation module SE, a data extraction module XTR, a processing and quantization module TT, a module MLP corresponding to an artificial neural network, a neural network encoding module NNC, a feature map encoding module FMC, a performance function evaluation module EVAL, an update module MAJ, an optional additional feature map generation module FME.

The encoding device ENC can be implemented by means of an electronic device comprising a processor and a memory (not shown); each of the aforementioned modules then can be produced via the interaction of the processor and computer program instructions that are stored in the aforementioned memory and are designed to perform the functionalities of the module in question, notably as described below, when these instructions are executed by the processor.

The encoding device ENC shown in FIG. 1 receives as input a sequence of at least two images to be encoded, denoted I(Pvₙ), each respectively comprising a plurality of samples Pvₙ. The index v indicates the image number in the sequence of V images. The index n indicates the pixel number in an image of N pixels. The image I(Pvₙ) can represent a two-dimensional image and the sequence of a plurality of two-dimensional images (video sequence, stereoscopic components, multiscopic components, series of medical images, etc.). In one embodiment, an image of the sequence is represented by means of at least one two-dimensional representation, such as a matrix of pixels, with each pixel comprising a vector of red (R), green (G), blue (B) components, or as a variant, a brightness component and at least one chroma component. The location of each pixel is defined by its x- and y-coordinates (xₙ and yₙ) in the image. In one embodiment, the sequence is a sequence of grayscale images represented by means of a two-dimensional representation, such as a matrix of pixels, with each pixel having a grayscale or brightness component. In this case, the vector representing the pixel is reduced to a single component.

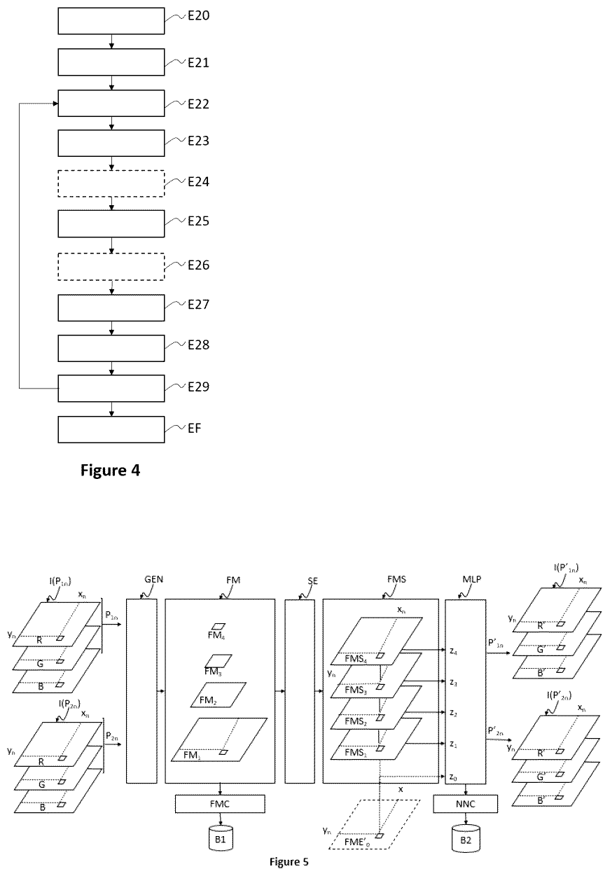

As will be described in greater detail hereafter with reference to FIGS. 4 to 7:

The feature map generation module GEN is configured to generate a plurality of M feature maps of a first group, denoted FMᵢ, from the sequence of input images I(Pvₙ). The optional module FME can also generate one or more additional maps (L in number), which will neither be encoded nor transmitted, and which are denoted FMEₗ.

In one embodiment, the module SE transforms the first group of feature maps in order to generate a second group of feature maps with the same resolution as the images of the input sequence. The optional module SE can quantize the values of the maps of the first group, by using a quantizer Q to generate an ordered collection of quantized values. It should be noted that the quantization of a value refers to matching this value with a member of a discrete set of possible code symbols. For example, the set of possible code symbols can be made up of integer values, and the quantization system simply rounds an actual value to an integer value. According to another example, quantization involves multiplication by a given value and then rounding. Next, the module SE transforms the values of at least one of the feature maps, for example, by up-sampling, interpolation, filtering, etc. At the end of the transformation, a transformed feature map of the second group has the same resolution as the images of the input sequence. Advantageously, according to this embodiment, the feature maps that are encoded can have lower resolution than that of the images to be encoded, while the maps of the second group, which are used to construct the feature vectors, have the same resolution as the sequence of images, thereby facilitating the extraction of the values.

In one embodiment, the module SE is absent, in this case the values that will be used to construct the feature vector are extracted from the first group of feature maps. The module XTR extracts values in the feature maps FMᵢ (and/or FMSi and/or FMEₗ, according to one of the previously described embodiments), for a sequence of current samples Pvₙ to be encoded, as a function of its coordinates in the respective input images. For example, when intending to encode the samples P₁n at the coordinates (xₙ, yₙ) of image number 1 and P₂n at the coordinates (xₙ, yₙ) of image number 2 of the sequence, the module XTR extracts values in the maps at positions imposed by the coordinates (xₙ, yₙ) of the current pixels.

In one embodiment, the extracted values form the vector Zₙ. Zₙ is a J-tuple, i.e., it contains J elements, or data zᵢ. The index n refers to the feature vector of the sequence of current samples, or pixels, P′ᵥₙ.

In one embodiment, the optional module TT processes the extracted values in order to generate the vector Zₙ. The module TT can quantize the data extracted from the set of feature maps. The processing can include other operations, such as filtering, scaling, etc. In particular, if the module SE is not used and if the feature maps of the first group have lower resolutions than the images of the sequence, the module TT can take into account the coordinates of the values in the maps with lower resolutions.

It should be noted that at least one of the modules SE or TT must quantize the feature maps.

The module MLP is a neural network that is defined by K parameters Wₖ, and that is capable of processing the vector Zₙ, or J-tuple, as input, in order to generate a sequence of vectors representing a sequence of samples P′ᵥₙ to be encoded as output. According to one embodiment, the neural network is an MLP, or Multi-Layer Perceptron, made up of an input layer adapted to the input format (the J-tuple), optionally one or more hidden layers, and an output layer adapted to the output format of the output vectors, generally a plurality of vectors each containing A elements. According to one embodiment, A is equal to 3 and an output vector is an (R, G, B) triplet of one of the N pixels P′ᵥₙ of the image v, encoded and then decoded.

The module NNC encodes the neural network, notably its parameters Wₖ. During the encoding training or construction process, i.e., as long as the step of evaluating performance remains unsatisfactory, the module NNC simulates the encoding, followed by decoding, the results of which are sent to the evaluation module. The evaluation module updates the values of the parameters as a function of the results of a performance measurement carried out by the module EVAL. Subsequently, it carries out the actual encoding of the parameters Wₖ of the neural network. The encoded parameters are denoted Wcₖ. In a known manner, the encoding simulation can be identical to the actual encoding, or can approximate it.

The module FMC encodes the maps FMᵢ, i.e., values of the feature maps of the first group (excluding any additional maps FMEₗ, and maps of the second group, optionally resulting from up-sampling by the module SE). During the encoding training or construction process, i.e., as long as the step of evaluating performance remains unsatisfactory, the module FMC simulates the encoding, followed by decoding, the results of which are sent to the evaluation module. Subsequently, it performs the actual encoding of the values of the maps FMᵢ. The encoded maps are denoted FMcᵢ. In a known manner, the encoding simulation can be identical to the actual encoding, or can approximate it. The encoding module quantizes, if necessary, the latent representation of the values of the maps of the first group, by using a quantizer to generate an ordered collection of quantized values. Next, the encoding module compresses the quantized data using entropy encoding, for example.

The module EVAL performs an evaluation and minimization of an encoding performance. The evaluation function is of the bit rate-distortion type, for example. The minimization can be performed via a gradient descent, or any other method within the ability of a person skilled in the art.

The module MAJ updates the values of the maps FMᵢ to be encoded as a function of the results of the performance function.

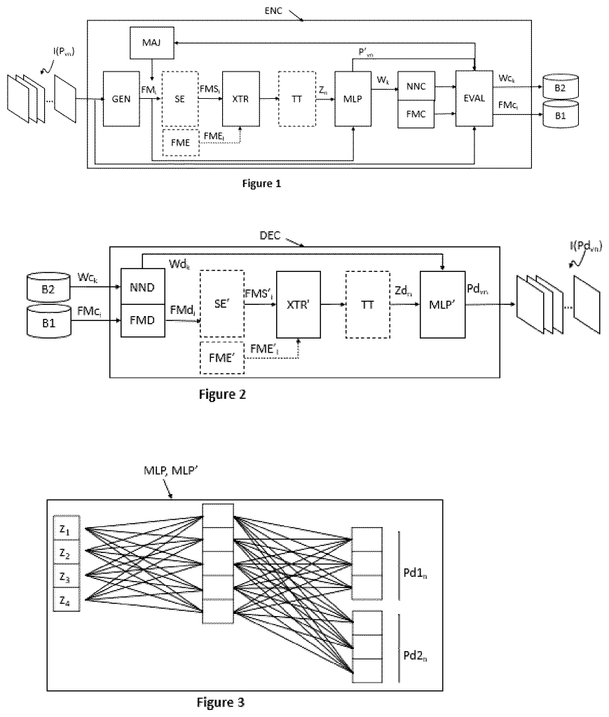

FIG. 2 schematically shows a decoding device DEC.

The decoding device DEC of FIG. 2 receives as input a first group of encoded data organized into M feature maps FMcᵢ (also called layers FM) and the encoded parameters Wcₖ of the neural network. It decodes the N sequences of samples Pdᵥₙ of the V images of the sequence to be decoded.

This decoding device DEC comprises a neural network decoding module NND, a feature map decoding module FMD, a data extraction module XTR′, an inverse transformation module SE′, a processing and inverse quantization module TT′, a module MLP′ corresponding to a neural network, an additional optional feature map generation module FME′. It outputs a sequence of decoded images, denoted I(Pdᵥₙ), each respectively comprising a plurality of decoded samples Pdᵥₙ.

The maps decoded by the module FMD, M in number, are denoted FMdᵢ. The parameters decoded by the module NND are denoted Wdₖ.

The decoder can also generate one or more additional maps, denoted FME′ₗ, L in number, and which are identical to the additional maps FMEₗ generated by the encoder.

In one embodiment, the module SE′ transforms the first group of decoded feature maps FMdᵢ in order to generate a second group of feature maps with the same resolution as the images to be decoded, denoted FMS′ᵢ. The module SE′ optionally performs an inverse quantization corresponding to the quantization performed on the encoder. The inverse quantization is not necessary if the quantizer Q of the encoder simply rounded the actual values it received. The inverse quantization is not necessary either if the neural network is able to take into account quantization of its input data. Otherwise, the decoder performs the inverse operation of the quantizer Q. Then, the module SE′ transforms the values of the feature maps, including, for example, up-sampling, interpolation, filtering, etc., similar to that performed by the encoder. Upon completion of the transformation, a transformed feature map of the second group has the same resolution as the images of the sequence to be decoded.

In one embodiment, the module SE′ is absent, in this case the values that will be used to construct the feature vector are extracted from the first group of feature maps.

The module XTR′ is identical to the module XTR of FIG. 1. It extracts values of the M feature maps FMdᵢ (and/or FMS′ᵢ and/or FME′₁, according to one of the previously described embodiments), for a sequence of current samples Pdᵥₙ to be decoded, as a function of the coordinates of the samples in the respective images to be decoded. In one embodiment, J=M. In one embodiment, J=M+L.

In one embodiment, the extracted values form the vector Zdₙ. Zdₙ is a J-tuple, i.e., it contains J elements, or data zdᵢ.

In one embodiment, the optional module TT′ processes the extracted values in order to generate the vector Zdₙ. The module TT can perform inverse quantization of the data extracted from the set of feature maps. The processing can include other operations, such as filtering, scaling, etc., similar to those performed by the encoder.

The module MLP′ is a neural network that is defined by K parameters Wdₖ, and that is capable of processing the vector Zdₙ, or J-tuple, as input, in order to generate a sequence of vectors as output representing a sequence of samples Pdᵥₙ, each comprising A elements. According to one embodiment, A=3 and an output vector is the (R, G, B) triplet of one of the N pixels Pdᵥₙ of the image v to be decoded. The module MLP′ has an identical structure to the module MLP, and its parameters are either identical if the encoding of its parameters Wₖ is lossless, or different if the encoding is lossy.

When all the sequences of samples Pdᵥₙ have been decoded, a sequence of reconstructed images is available, according to the example V images I(Pdᵥₙ), each containing N samples.

The decoding device DEC can be implemented by means of an electronic device comprising a processor and a memory (not shown); each of the aforementioned modules then can be produced via the interaction of the processor and computer program instructions that are stored in the aforementioned memory and are designed to perform the functionalities of the module in question, notably as described below, when these instructions are executed by the processor.

FIG. 3 illustrates an example of a synthetic artificial neural network used within the scope of the invention during encoding and decoding.

The synthetic artificial neural network MLP used for encoding and the synthetic artificial neural network MLP′ used for decoding are defined by an identical structure, for example, comprising a plurality of layers of artificial neurons, and by a set of weights and activation functions respectively associated with the artificial neurons of the network in question.

A vector representation of a sequence of current samples (a vector Zₙ or Zdₙ obtained from the feature maps FMᵢ/FMSᵢ and FMEₗ or FMdᵢ/FMS′ᵢ and FME′₁) is applied to the input (i.e., to an input layer) of the synthetic artificial neural network MLP or MLP′. The artificial neural network produces as output a plurality of vectors P′ᵥₙ or Pdᵥₙ representing reconstructed (during encoding) or decoded (during decoding) samples, according to one embodiment the constituent color components (R, G, B) of the color pixels of a sequence of images. In FIG. 3, the sequence of images corresponds to two images, each sequence of samples contains two samples, and the corresponding vectors are denoted Pd₁ₙ and Pd₂ₙ.

The concatenation of all the reconstructed pixels in each of the images in the output sequence forms the sequence of decoded images (on the decoder) or reconstructed images (on the encoder).

On the encoder, the synthetic artificial neural network MLP is trained on the sequence of images, so as to minimize the differences between the input representation of the sequence of current images I(Pvₙ) and its output representation I(P′ᵥₙ), while also minimizing the amount of data to be encoded. The module EVAL performs a performance measurement in this sense.

Once the training has ended, the parameters of the network are encoded either losslessly, in which case the neural network MLP′ is identical to MLP, or with losses, in which case the network MLP′ can be slightly different from MLP.

FIG. 4 is a flowchart showing an example of an encoding method that can be implemented by the encoding device of FIG. 1.

According to this embodiment, the sequence is a sequence of two-dimensional images, each sequence of samples to be encoded is therefore a set of pixels Pᵥₙ of coordinates (xₙ, yₙ) in the respective images I(Pvₙ) of the sequence to be encoded.

Encoding takes place in two main phases:

In a first phase, called construction phase, learning is performed, in order to determine, for an input sequence I(Pvₙ), the values of the maps FMᵢ and parameters Wₖ in order to optimize an overall cost function. The learning is, for example, carried out via gradient descent, followed by an update of the parameters of the neural network MLP and of the values of the feature maps FMᵢ. As is known in the prior art, the cost function can be of the bit rate-distortion type, or can be of the bit rate, or distortion, or perceptual type. In order to measure the bit rate R, the encoding of the maps FMᵢ needs to be simulated, then the associated encoding bit rate (the size of the stream B1) needs to be measured. According to one embodiment, the encoding of the parameters Wₖ is not simulated because their influence is less than that of the feature maps. According to one embodiment, the encoding of the parameters Wₖ is also simulated and the associated bit rate (the size of the stream B2) is measured. In order to measure the distortion D, the encoding and then the decoding of at least one part of the sequence of images needs to be simulated in order to obtain at least one sequence of pixels P′ᵥₙ resulting from a simulation of encoding and then decoding of the samples of index n, then the difference between this part of the sequence of images I(Pvₙ) as input and a corresponding part of the encoded and then decoded sequence I(P′ᵥₙ) needs to be measured.

Next, during a second phase, called encoding phase, the maps FMᵢ and the parameters Wₖ are encoded to produce the encoded values FMcᵢ and Wcₖ before transmission or storage. They form the compressed representation of the input sequence I(Pvₙ).

The steps of a method according to one embodiment of the invention will now be described.

During a step E20, an input sequence I(Pvₙ) to be encoded, comprising at least two images, each together comprising a plurality of N samples Pₙ, is delivered to the method as input. According to one embodiment, these images are temporal images of a video sequence. According to one embodiment, these images are images of a series of images, for example, medical images. According to one embodiment, these images are multiview or 3D components of an image or a sequence of multiview or 3D images.

During a step E21, the M maps FMᵢ of the first group are initialized. Subsequently, the parameters Wₖ of the neural network MLP and the values of the maps FMᵢ must be optimized during the construction phase.

According to one embodiment, the maps FMᵢ have the same resolution as the images of the input sequence I(Pvₙ) and therefore each comprise the same number of values N as there are samples Pᵥₙ to be encoded in each image v.

According to one embodiment, the resolution of the maps FMᵢ is less than or equal to that of the images of the input sequence I(Pvₙ) and they therefore comprise, for at least one of them, a number N′ of values to be encoded that is less than N. According to one variant, the first map FMᵢ has the resolution of the images and each subsequent map has half the resolution of the previous one.

According to one embodiment, a plurality of maps FMᵢ have the same resolution, less than the resolution of the input sequence I(Pvₙ).

According to one embodiment, the maps FMᵢ are transformed in order to provide a second group of transformed feature maps FMSᵢ. In this embodiment, the feature vectors are preferably extracted from the transformed maps of the second group, and not directly from the maps of the first group. In this embodiment, the feature vectors are therefore indirectly extracted from the maps of the first group. The maps of the second group are neither encoded nor transmitted, they are only used to construct the feature vectors.

According to one embodiment, the maps FMᵢ are initialized with predefined constant values.

According to another embodiment, the feature maps are initialized with a set of random real values.

According to one embodiment, one or more maps FMEₗ, forming an additional group of L additional feature maps, is/are generated and added to the first group. They are used to construct the feature vector but will not be stored or transmitted.

The feature maps FMᵢ of the first group are subsequently updated, or refined, during a step E22, by the updating module MAJ of the encoder during its learning phase.

During a step E23, the maps FMiᵢ of the first group are encoded by the module FMC of the encoder. During the construction phase, this operation is an encoding simulation. During the encoding phase, this operation is actual encoding and the encoded values form the stream B1. The simulation can be identical to the actual encoding, but it also can be different (for example, simplified). For this encoding, it is possible to use any known technique aimed at compressing the values of the maps.

In one embodiment, the maps FMᵢ are encoded in the order (FM₁, FM₂, . . . , FM₄), and the variables of each map are encoded in a predefined order, in a lexicographic order, for example. Each map undergoes entropy encoding. The entropy encoding produces a compressed stream B1, the bit rate of which is subsequently measured during a step E29.

During a step E24, according to one embodiment, the M maps of the first group FMᵢ are transformed by the module SE in order to generate maps of the second group FMSᵢ with the resolution of the images of the input sequence.

According to one embodiment, M maps FMSᵢ are generated.

According to one embodiment, each map FMᵢ is transformed into a map FMSᵢ.

According to one embodiment, at least one map FMᵢ has lower resolution than that of the images of the sequence to be encoded and the transformation operation comprises up-sampling, so that the transformed map FMSᵢ comprises the same number of samples as the images of the sequence. The up-sampling involves adding values to the maps FMSᵢ in order to achieve the resolution of the images of the input sequence. It can be simple (by replicating the nearest neighbor) or include an interpolation (linear, polynomial, filtering, etc.).

During a step E25, values of the transformed maps FMᵢ, or optionally FMSᵢ, and optionally the additional map FMEᵢ, are extracted by the module XTR. This extraction is performed as a function of the coordinates (xₙ, yₙ) of the sequence of current samples Pᵥₙ of the input images. It also can be performed as a function of the resolution of the map in question. The sequences of samples to be encoded are, for example, processed in sequential order, from n=1 to n=N.

According to one embodiment, the feature vector Zₙ directly results from this extraction.

According to one embodiment, during a step E26, the feature vector Zₙ is constructed by the module TT from the values extracted from the maps FMᵢ or FMSᵢ, and optionally FMEₗ, for each sequence of samples Pᵥₙ of coordinates (xₙ, yₙ) of the input images. The processing can involve quantizing the extracted values or the constituent vector Zₙ, if necessary. The processing can include other operations, such as filtering, scaling, applying any function, preferably a monotonous function, etc.

In one embodiment, Zₙ comprises as many values as there are input maps FMᵢ or FMSᵢ (and optionally FMEₗ). In this case, J=M(+L).

In one embodiment, Zₙ is a J-tuple (z1, z2, . . . , z_{J}) formed from the values of the maps FMᵢ or FMSᵢ (and optionally FMEₗ) located at the coordinates (xₙ, yₙ) of a current pixel Pₙ, as will be illustrated with reference to FIG. 5.

In one embodiment, Zₙ is a J-tuple constructed from values sampled from the maps FMᵢ (and optionally FMEₗ) at coordinates that can differ depending on the maps. For example, if the maps FMᵢ (and/or FMEₗ) have different resolutions because they have been down-sampled, the coordinates are adapted (by scaling) to match the resolution of each map.

In one embodiment, Zₙ is a J-tuple constructed from values sampled from the maps FMᵢ (and optionally FMEₗ) by applying the processing to one or more values of the maps, for example, filtering neighboring values of the targeted value in a map. For example, in a map FMᵢ that has the same resolution as the input signal, it is possible to extract the values located at the coordinates (xₙ, yₙ), (xₙ-1, yₙ), (xₙ, yₙ-1) and (xₙ-1, yₙ-1) and to process these values (filtering, averaging, interpolation, etc.) in order to obtain the final value (zᵢ) of the element i of the vector Zₙ relating to this map FMᵢ or FMEₗ. According to another example, in a map FMᵢ that has half the resolution of the input signal, the values located at the coordinates (xₙ/2, yₙ/2), (xₙ/2-1, yₙ/2), (xₙ/2, yₙ/2-1) and (xₙ/2-1, yₙ/2-1) can be considered and these values can be processed (filtering, averaging, interpolation, etc.) in order to obtain the final value (zᵢ) of the element i of the vector Zₙ relating to this map FMᵢ or FMEₗ.

During a step E27, the vector Zₙ is processed by the neural network MLP to generate the sequence of samples Pᵥₙ to be encoded as output, namely, according to one embodiment, the (R, G, B) triplets of the samples P′ᵥₙ (the samples Pᵥₙ encoded and then decoded).

The structure and the parameters Wₖ of the neural network are initialized, for example, in the first iteration of this step. These parameters are subsequently updated, or refined, during the construction phase, during subsequent iterations of the method.

According to one embodiment, the parameters of the neural network are initialized with predefined values that are known to yield a satisfactory result (for example, following training on a corpus of images).

According to another embodiment, the parameters Wₖ of the neural network are initialized with a set of random values.

During a step E28, the parameters Wₖ of the neural network MLP are quantized and encoded. During the construction phase, this operation is an encoding simulation. During the encoding phase, this operation is actual encoding and the encoded values form the stream B2. The simulation can be identical to the actual encoding, but it also can be different (for example, simplified). To this end, any known technique can be used, for example, the neural network coding standard proposed in part 17 of the MPEG-7 standard, also called Neural Network Representation or NNR. It should be noted that in this case, the amount of degradation that the encoding causes to the parameters Wₖ needs to be selected.

During a step E29, a performance measurement is evaluated.

To this end, the encoding simulation bit rates associated with the feature maps of the first group (simulation of the stream B1 by encoding the maps FMᵢ) and optionally with the parameters of the neural network (simulation of the stream B2 by encoding the parameters Wₖ) are measured.

According to one embodiment, the cost function is of the bit rate-distortion type, denoted (D+L*R), for example, the squared error measured between the input signal and the decoded images (or the error measured on a subset of samples of the images). According to another example, D is computed from a perceptual function such as SSIM (Structural SIMilarity), or MSSSIM (Multi-scale Structural SIMilarity). According to one embodiment, R is the simulated bit rate of the stream B1; according to another embodiment, R is the total bit rate used to encode this image, i.e., the sum of the simulated bit rates of B1 and B2. L is a parameter that adjusts the rate-distortion compromise. Other cost functions are possible.

Until the cost function reaches its minimum, the performance measurement remains unsatisfactory, and the method is repeated from step E22. This minimization can be carried out via a known mechanism such as gradient descent with parameters updated in step E22 as regards the values of the feature maps and step E27 as regards the parameters of the network.

During a step EF, if the cost function has reached its minimum, the training stops. If an encoded version corresponding to the last simulation of the parameters of the neural network (Wₖ) and of the feature maps (FMᵢ) is available, the streams B1 and B2 can be formed therefrom. According to another embodiment, the actual encoding of the updated parameters of the neural network (Wₖ) and of the values of the feature maps (FMᵢ) is carried out in this step to produce the encoded parameters Wcₖ and FMcᵢ forming the streams B1 and B2.

The streams B1 and B2 can be concatenated to produce a final stream. According to one embodiment, the stream B2 of the encoded parameters of the neural network is stored or transmitted before the stream B1, in order to be able to be decoded before the stream B1.

FIG. 5 shows an illustration of an encoding method used in one embodiment of the invention.

In this illustration, a sequence of two images I(P₁ₙ) and I(P₂ₙ) is to be encoded. In general, a sequence of V images I(Pᵥₙ) is applied to the method and the encoding device as input. In this illustration, the samples, or pixels, are processed in sequences of two, with two pixels being sampled from the respective images at a position denoted (xₙ, yₙ), with n varying from 1 to N. (P₁ₙ is sampled from image 1 at position (xₙ, yₙ) and P₂ₙ is sampled from image 2 at position (xₙ, yₙ)).

In this embodiment, there are 4 generated maps FMᵢ. In a preferred embodiment, there are 7 maps.

The first map FM₁ has the same resolution as the image I, and therefore contains N=W×H variables, where W represents the width of the image in pixels, and H its height. The second map FM₂ has half the resolution (in each dimension) of the map FM₁. Each additional map has half the resolution of the previous map. This structure allows the number of variables in the feature maps to be decreased, thus facilitating encoding and learning, while minimizing the encoding cost.

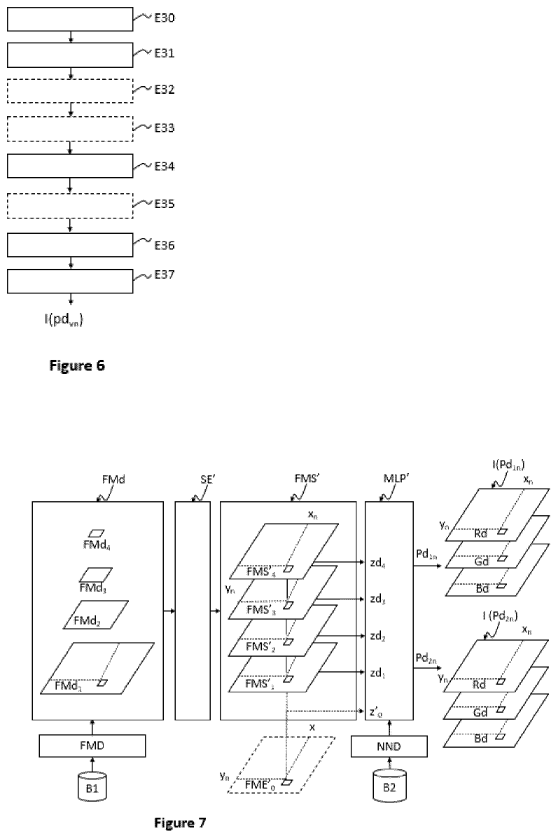

The map FM₂ is up-sampled by the module SE by a factor of 2 in each dimension, according to a method illustrated with reference to FIG. 6. The map FM₃ is up-sampled by a factor of 4 in each dimension, and the map FM₄ by a factor of 8 in each dimension.

The resulting maps FMSᵢ have the same resolution as the images I(Pvₙ), and therefore each comprise W×H values, where W represents the width of the image in pixels and H its height (N=W×H).

According to this embodiment, the layers FMᵢ are quantized by the module SE.

Other types of structure are possible, for example, a reduction rate other than a half can be used between the maps (one quarter, or one third, etc.).

In a variant shown with dashed lines, there are 5 feature maps: an additional map FME₀ has been introduced, which will be neither encoded nor transmitted. This additional map typically includes data that can assist the network MLP with the task of reconstructing images. Thus, the added maps can be one or more maps from the following non-limiting list:
A map containing, at each point, the x-coordinate of this point.
A map containing, at each point, the y-coordinate of this point.
A map containing positional encoding at each point (as described, for example, at the following website: https://skosmos.loterre.fr/P66/fr/page/-KOD65X2X-X).
A map representing an image distinct from the images being processed, and capable of providing information concerning the images to be encoded, for example, a previously processed image or sequence of images.
A map containing data representing the temporal difference between the images of the video being decoded. For example, if the first and last image of the video are 8 images apart, all the samples in the map contain the value 8.
A map representing a feature map of an image distinct from the images being processed, and capable of providing information concerning the images to be encoded, for example, a previously processed map.
A map containing the value of an already decoded sample of the same map, for example, the previous sample in the decoding order.

In this embodiment, the vector Zₙ is a 4-tuple (z₁ . . . z₄) formed from values extracted from the maps FMSᵢ located at the coordinates (xₙ, yₙ) of the sequence of current pixels Pᵥₙ. The vector Zₙ made up of the (quantized) extracted values of the maps FMSᵢ is processed by the neural network MLP in order to output a sequence of vectors, according to the example two triplets representing samples P₁ₙ and P₂ₙ to be encoded. The output vectors in this embodiment are the (R, G, B) triplets of the encoded and then decoded pixels P′₁ₙ and P′₂ₙ. The triplets are inserted into the decoded images I(P′₁ₙ) and I(P′₂ₙ) at the positions (xₙ, yₙ) of the color components (R′, G′, B′) of the two images.

In another embodiment, not shown, the vector Zₙ is extracted directly from the layers FMᵢ, at the positions recomputed as a function of the size of the maps, and then the extracted values are optionally processed and quantized after extraction.

According to the variant shown as dashed lines, the vector Zₙ is a 5-tuple (z₀ . . . z₄), with the value z₀ being extracted from the additional map FME₀.

FIG. 6 is a flow chart showing an example of a decoding method that can be performed by the decoding device of FIG. 2.

During a step E30, the streams B1 and B2 are extracted from the encoded stream BS. They respectively contain the encoded representations of the maps of the first group FMcᵢ and of the parameters Wcₖ.

During a step E31, the M maps FMdᵢ are generated by decoding the values FMcᵢ. For this decoding, any known technique can be used that is similar to that used in the encoder, and preferably entropy decoding. In one embodiment, the maps FMdᵢ are decoded in the order (FMd₁, FMd₂, . . . , FMd₄), and the variables of each map are decoded in a predefined order, for example, in a lexicographic order.

According to embodiments as described for the encoder:
The maps FMdᵢ have the same resolution as the images of the sequence I(Pdᵥₙ) to be reconstructed, i.e., they contain N=W×H values.
The maps FMdᵢ have a resolution that is less than or equal to that of images of the sequence I(Pdᵥₙ) to be reconstructed.
A plurality of maps FMdᵢ have the same resolution, lower than the resolution of the images of the sequence.

During a step E32, according to one embodiment, one or more maps FME′ₗ, forming an additional group of L additional feature maps, is/are generated and supplement the first group. They are not decoded, but are generated by the decoder in the same way they are generated in the encoder. They typically include data that can assist the network MLP′ in the task of reconstructing images of the sequence. The non-limiting list of possible additional feature maps described with reference to FIG. 5 for the encoder is also applicable in this case.

During a step E33, according to one embodiment, the M maps of the first group FMdᵢ are transformed by the module SE in order to generate maps of the second group FMS′ᵢ with the resolution of the images of the input sequence.

According to one embodiment, M maps FMS′ᵢ are generated.

According to one embodiment, each map FMdᵢ is transformed into a map FMSᵢ.

According to one embodiment, at least one map FMdᵢ has lower resolution than that of the images of the sequence to be encoded and the transformation operation comprises up-sampling, so that the transformed map FMS′ᵢ comprises the same number of samples as the images of the input sequence. As on the encoder, the up-sampling involves adding values to the maps FMS′ᵢ in order to achieve the resolution of the images of the input sequence. It can be simple (replication of the nearest neighbor) or comprise an interpolation (linear, polynomial, filtering, etc.).

The transformation can optionally comprise an inverse quantization of the extracted values, if necessary. However, inverse quantization is not mandatory.

During a step E34, values of the transformed maps FMdᵢ, or optionally FMS′ᵢ, and optionally the additional map FME′ᵢ, are extracted by the module XTR′. This extraction is performed as a function of the coordinates (xₙ, yₙ) of the sequence of current samples Pᵥₙ to be decoded of the images of the sequence. It also can be performed as a function of the resolution of the map in question. The sequences of samples to be decoded are processed, for example, in sequential order, from n=1 to n=N.

According to one embodiment, the feature vector Zₙ directly results from this extraction.

Notably, in one embodiment, Zdₙ is a J-tuple (z1, z2, . . . , z_{J}) formed from the values of the maps FMdᵢ or FMS′ᵢ (and optionally FME′₁) located at the coordinates (xₙ, yₙ) of a current pixel Pdᵥₙ, as will be illustrated with reference to FIG. 7.

According to one embodiment, during a step E35, a vector Zdₙ is constructed by the module TT′ from the values extracted from the maps FMdᵢ of the first group or from the maps FMS′ᵢ of the second group, and optionally from the maps FME′ᵢ of the additional group, for each sequence of samples Pdᵥₙ of coordinates (xₙ, yₙ) of the input images to be decoded, as a function of the coordinates (xₙ, yₙ). This step is identical to step E26 that was described for the encoder with reference to FIG. 4 and the described embodiments are applicable. The extraction can comprise an inverse quantization of the extracted values or of the formed vector Zdₙ, if necessary.

During a step E36, the parameters Wdₖ of the neural network MLP′ are generated by decoding the values Wcₖ of the stream B2. To this end, any known decoding technique corresponding to the encoding technique used by the encoder can be used. The neural network MLP′ is similar to the network MLP, i.e., it has the same structure and the same parameters, to the nearest encoding, which can be lossy or lossless.

According to one embodiment, the stream B2 is decoded before the stream B1, in order to obtain the neural network before starting to decode the sequences of samples.

During a step E37, the vector Zdₙ is processed by the neural network MLP′ to generate as output the sequence of current samples Pdᵥₙ to be decoded, according to one embodiment the (R, G, B) triplets of the samples Pdᵥₙ. The samples are inserted into the decoded images I(Pdᵥₙ) at the positions (xₙ, yₙ) of the color components (Rd, Gd, Bd) of the respective images of the sequence. This step is identical to step E27 that was described for the encoder with reference to FIG. 4.

When all the sequences of samples have been processed, the corresponding sequence of decoded images is available.

FIG. 7 shows an illustration of a decoding method used in one embodiment of the invention.

In this illustration, a sequence of two images I(Pd₁ₙ) and I(Pd₂ₙ) is to be decoded. In general, a sequence of V images I(Pdᵥₙ) is decoded by the method and the encoding device. In this illustration, the samples, or pixels, are processed in sequences of two, with two pixels being decoded and reconstructed from the respective images at a position denoted (xₙ, yₙ), with n varying from 1 to N. (Pd₁ₙ is inserted into image 1 at position (xₙ, yₙ) and Pd₂ₙ is inserted into image 2 at position (xₙ, yₙ)).

In this embodiment, there are 4 maps FMdᵢ. In a preferred embodiment, there are 7 maps.

In this embodiment, the first map FMd₁ has the same resolution as the image I, and therefore contains W×H variables, where W is the width of the image in pixels, and H its height. The second map FMd₂ has half the resolution (in each dimension) of the map FMd₁. Each additional map has half the resolution of the previous map. This structure allows the number of variables in the feature maps to be decreased, thus facilitating decoding, while minimizing the decoding cost.

The map FMd₂ is up-sampled by the module SE′ by a factor of 2 in each dimension, according to any up-sampling method within the capability of a person skilled in the art. The map FMd₃ is up-sampled by a factor of 4 in each dimension, and the map FMd₄ by a factor of 8 in each dimension.

The maps FMS′ᵢ have the same resolution as the image to be decoded, and therefore contain W×H values, where W is the width of the image in pixels and H its height.

In this embodiment, the vector Zdₙ is a 4-tuple (z₁ . . . z₄) formed from values of the maps FMS′ᵢ located at the coordinates (xₙ, yₙ) of the sequence of current pixels Pdᵥₙ. The vector Zdₙ is optionally dequantized and then processed by the neural network MLP′ to generate the respective (R, G, B) or (Y, U, V) triplets of the two samples Pdᵥₙ (Pd₁ₙ and Pd₂ₙ) to be decoded as output. The triplets (R, G, B or Y, U, V) are inserted into the respective decoded images I(Pd₁ₙ) and I(Pd₂ₙ) at the coordinates (xₙ, yₙ) in the color components (Rd, Gd, Bd) or (Yd, Ud, Vd) of the images.

According to a variant shown as dashed lines, there are 5 maps: an additional map FME′₀ has been introduced. In this embodiment, the vector Zdₙ is a 5-tuple.

1. A method for encoding a sequence of at least two images comprising samples to be encoded, implemented by an encoding device and comprising:
constructing a first group of feature maps;
for a sequence of samples, called current samples, of said respective images of the sequence, associated with a position in said respective images:
constructing a feature vector from said feature maps of said first group, as a function of said position of said current samples; and
processing said vector using a neural network defined by a set of parameters, in order to provide a sequence of vectors respectively representing decoded values of said current samples;
updating at least one value of one of said feature maps of said first group and/or at least one parameter of said network, as a function of an encoding performance measurement;
encoding said first group of feature maps and said set of parameters.

2. The method for encoding a sequence of images as claimed in claim 1, wherein the method comprises transforming said first group of feature maps to obtain a second group of feature maps with a same resolution as that of the images of the input sequence, and wherein said feature vector is constructed from said transformed feature maps of the second group obtained from said feature maps of said first group.

3. The method for encoding as claimed in claim 2, wherein at least one of said feature maps of the first group has lower resolution than that of said images to be encoded and wherein the transformation operation involves up-sampling.

4. The method for encoding as claimed in claim 1, wherein the construction of said feature vector comprises a sub-step of extracting a value of at least one of said feature maps in an identical position to that of the current samples in said images to be encoded.

5. The method for encoding as claimed in claim 1, wherein the construction of said feature vector comprises the following steps:
extracting a plurality of values of said feature maps of said first group as a function of said position of said current samples;
processing said extracted values in order to obtain the feature vector.

6. The method for encoding as claimed in claim 1, wherein the method comprises constructing an additional group of feature maps, and wherein the feature vector is also constructed from said feature maps of the additional group.

7. The method for encoding as claimed in claim 1, wherein encoding said first group of feature maps comprises a sub-step of entropy encoding.

8. A method for decoding a sequence of at least two images comprising samples to be decoded, implemented by a decoding device and comprising:
obtaining, by decoding, a first group of feature maps;
obtaining, by decoding, a set of parameters representing a neural network;
for a sequence of samples, called current samples, of said respective images of the sequence to be decoded, associated with a position in said respective images:
constructing a feature vector from the feature maps of said first group, as a function of said position of said current samples, and:
processing said vector using a neural network defined by the decoded parameters in order to provide a sequence of vectors respectively representing said current samples.

9. The method for decoding as claimed in claim 8, wherein the method comprises transforming said first group of decoded feature maps to obtain a second group of feature maps with a same resolution as that of the images of the input sequence, and wherein said feature vector is constructed from said transformed feature maps of the second group obtained from said decoded feature maps of said first group.

10. The method for decoding as claimed in claim 9, wherein at least one of said feature maps of the first group has lower resolution than that of said images to be decoded and wherein the transformation operation involves up-sampling.

11. The method for decoding as claimed in claim 8, wherein the construction of said feature vector comprises extracting a value of at least one of said feature maps in an identical position to that of the current samples in said images to be decoded.

12. The method for decoding as claimed in claim 8, wherein the construction of said feature vector comprises:
extracting a plurality of values of said feature maps of said first group as a function of said position of said current samples;
processing said extracted values in order to obtain the feature vector.

13. The method for decoding as claimed in claim 8, wherein the method comprises of constructing an additional group of feature maps and wherein the feature vector is also constructed from said feature maps of the additional group.

14. The method for decoding as claimed in any claim 8, wherein decoding said first group of feature maps comprises a sub-step of entropy decoding.

15. A device for encoding a sequence of at least two images comprising samples to be encoded, wherein the device comprises:
at least one processor; and
at least one non-transitory computer readable medium comprising instructions stored thereon which when executed by the at least one processor configure the device to:
construct a first group of feature maps;
for a sequence of samples, called current samples, of said respective images of the sequence, associated with a position in said respective images:
construct a feature vector from said feature maps of said first group, as a function of said position of said current samples;
process said vector using a neural network defined by a set of parameters, in order to provide a sequence of vectors respectively representing decoded values of said current samples;
update at least one value of one of said feature maps and/or at least one parameter of said network, as a function of an encoding performance measurement;
encoding said first group of feature maps and said set of parameters.

16. A device for decoding a sequence of at least two images comprising samples to be decoded, wherein the device comprises:
at least one processor; and
at least one non-transitory computer readable medium comprising instructions stored thereon which when executed by the at least one processor configure the device to:
obtain, by decoding, a first group of feature maps;
obtain, by decoding, a set of parameters representing a neural network;
for a sequence of samples, called current samples, of said respective images of the sequence to be decoded, associated with a position in said respective images:
construct a feature vector from the feature maps of said first group, as a function of said position of said current samples, and
said vector using a neural network in order to provide a sequence of vectors respectively representing said current samples.

17. A non-transitory computer readable medium comprising a computer program stored thereon comprising instructions for executing the encoding method as claimed in claim 1 when said program is executed by a computer.

18. A non-transitory computer readable medium comprising a computer program stored thereon comprising instructions for executing the decoding method as claimed in claim 8 when said program is executed by a computer
